(19) United States
(12) Patent Application Publication
(10) Pub. No.: US 2026/0166762 A1
(43) Pub. Date: Jun. 18, 2026

(54) KNIFE

(71) Applicant: MARTOR KG, Solingen (DE)

(72) Inventor: Martin ROHRBACH, Göggingen (DE)

(21) Appl. No.: 19/377,472

(22) Filed: Nov. 3, 2025

(30) Foreign Application Priority Data
Dec. 6, 2024 (DE) 10 2024 136 592.7

(51) Int. Cl. B26B 1/08; B26B 1/10; B26B 5/00

(52) U.S. Cl. CPC B26B 1/08; B26B 1/10; B26B 5/003

(57) ABSTRACT

A knife including a holder and a blade device which is movable relative to the holder between a safety position and a cutting position. A handle is movable between an inactive position and an active position. The holder provides a contact surface for an actuating finger with which the handle is actuated, within reach of the movement path of the handle.

The invention relates to a knife.

The knife comprises a holder, which is configured e.g. in a housing-like manner, in which a blade device is movable between a safety position and a cutting position. In the safety device, the cutting edge of the blade is covered by the housing, such that injury of the user is excluded. In the cutting position, a region of the cutting edge protrudes out of the housing, such that a cut can be made. The blade device can be moved from the safety position into the cutting position by means of a handle which is movable between an inactive and an active position.

A knife of this kind is known from EP 3 112 009A1.

In the case of the above-described knife, in order not to impair the automatic retraction function of a return device for the blade carrier and thus reduce the safety of the knife, the handle for moving the blade device into the cutting position and for holding it in the cutting position is released as soon as the blade plunges into the material to be cut. The friction force between the blade and the material to be cut then holds the blade counter to the force of the return device in the cutting position. It has been shown that holding the thumb after removal of the handle is tiring for the user.

Furthermore, knives are known from the prior art, in which the blade device is movable by means of the handle into the cutting position, but the blade device cannot automatically move back into the safety position after a cutting process, even if the handle is located in the active position. In order that the blade device can be moved into the active position again, however, movement of the handle into the inactive position is necessary. Therefore in the case of these knives, too, the user has to release the actuating finger from the handle.

It has been shown that these movements of the actuating finger lead to the user becoming tired if they are performed frequently.

The object of the invention was that of providing a knife in which tiring of the actuating finger is reduced.

The object was achieved by a knife having the features of claim 1.

The knife according to the invention comprises a holder and a blade device. The blade device is e.g. a blade having a cutting edge or a blade holder in which it is possible to mount, e.g. detachably mount, a blade with a cutting edge. The blade device is movable relative to the holder between a safety position and a cutting position. The blade device can be moved out of the safety position into the cutting position, in that a handle, which is movable between an inactive position and an active position, is moved out of the inactive position into the active position.

The holder comprises a contact surface for the actuating finger, within reach of the movement path of the handle. The contact surface is a surface which is separate from the actuation surface of the handle and is immovable relative to the holder.

The user can thus remove the actuating finger from the handle and lay it on the contact surface, and thus prevent quick tiring. The return of the blade device is thus ensured. The actuating finger can nonetheless guide the knife on the contact surface and e.g. cause a rotation of the knife. Since the contact surface is arranged within reach of the handle, the user can quickly move the actuating finger back onto the handle again.

The blade device is loaded into the safety position e.g. by a return device. If there is no longer any counter force to the return force of the return device, the blade device is shifted back into the safety position. The knife thus provides a safety function with which the blade is automatically set back into the safety position in the case of unloading of the handle or in the case of knives with automatic blade retraction in which a coupling between the blade device and the handle is releasable.

The holder is configured e.g. at least in part as a housing. The blade can then be retracted into an interior of the housing in the safety position, such that the user is protected from touching the cutting edge. Other movable parts can also be received in the housing, for example, and thus injury to the user can be prevented. The housing can provide a space for replacement or auxiliary parts in an interior. The housing can furthermore simultaneously provide an ergonomic grip.

The contact surface is configured e.g. in parallel with a sagittal plane of the knife. Within the meaning of the invention and in accordance with the conventional use, a sagittal plane refers to a vertically extending plane which extends through a longitudinal central axis of the holder. Typically, at least one handle is arranged on a flank of the holder, e.g. a housing. For example, one handle may be arranged in each case on opposing flanks of the holder.

The contact surface is positioned on the housing for example in such a way that it is located within reach of the handle and the user's finger can easily move from the handle onto the contact surface. For example, the contact surface is arranged in such a way that—when the handle is in the active position—the user's finger has to perform the shortest movement from the handle to the contact surface. Since the contact surface is arranged in parallel with the sagittal plane, the user's finger merely has to perform a pivot movement, and not a torsional movement.

Alternatively, the contact surface is arranged approximately centrally between the position of the handle in the safety position and in the cutting position. Then, the contact surface can be easily reached from all positions of the handle. The blade can be extended less than to a maximum in certain cutting applications. This is the case for example if the cutting depth is less great. Therefore, arrangement on the contact surface is expedient, in the case of which this can also be easily reached from the intermediate position of the handle.

The contact surface is arranged for example under the handle. In this case, the user can easily allow the actuating finger to drop onto the contact surface. This position of the contact surface is also favorable for ergonomic reasons.

The contact surface is formed e.g. on a projection of the housing. In this case, the contact surface enlarges the holder only slightly. The optical appearance and the handling of the knife are not impaired by the projection. The projection can be produced for example integrally with the housing of the knife. It can be produced integrally with the holder for example in a plastics injection molding method or die casting method. The projection furthermore makes it easier to rotate the holder about its central axis.

For example, the contact surface comprises a depression which has a different level with respect to a neighboring region. The height level differs e.g. in the direction orthogonally to the sagittal plane. Owing to the different height levels, the actuating finger can intuitively feel and quickly assume its intended position on the contact surface. The height difference of the levels also prevents the actuating finger from slipping off the contact surface, because the elevation forms a delimitation.

The transition to the neighboring region forms e.g. a ramp between the recessed level and the neighboring height level. The actuating finger can then be moved from the level corresponding to the actuation surface of the handle to the recessed level without abrupt and unergonomic transitions.

The surface of the contact surface forms e.g. at least in regions a structure which stabilizes the actuating finger. The structure makes it more difficult for the actuating finger to slide relative to the contact surface. This promotes relaxed resting of the actuating finger on the contact surface.

The length of the contact surface is, e.g. corresponding to the longitudinal extension of the fingertip, greater than its width. Since the longitudinal extension of the fingertip of the actuating finger contacts the contact surface corresponding to its longitudinal extension, it is advantageous for this to be formed by a region of which the longitudinal extension is large in relation to its width, e.g. twice as large.

For example, in each case a handle and a contact surface is formed on opposing flank surfaces of the holder. The knife can then be used both by right-handed and by left-handed persons.

The holder can be produced e.g. from plastics material, a plastics composite, such as fiber-reinforced plastics material, or of a metal casting.

Embodiments of the invention are described by way of example in the following description of the figures, also with reference to the drawings. In this case, for the sake of clarity—even where different embodiments are concerned—identical or comparable parts or elements or regions are demoted by the same reference signs, sometimes with addition of lower-case letters.

Features which are described only in connection with one embodiment can also be provided, within the scope of the invention, in any other embodiment of the invention. Embodiments amended in this way—even if they are not shown in the drawings—are also covered by the invention.

All the disclosed features are per se essential to the invention. The disclosure content of the cited documents and the described devices of the prior art is also hereby included in its entirety in the disclosure of the application, also for the purpose of incorporating individual or multiple features of these documents into one or more claims of the present application.

In the schematic figures:

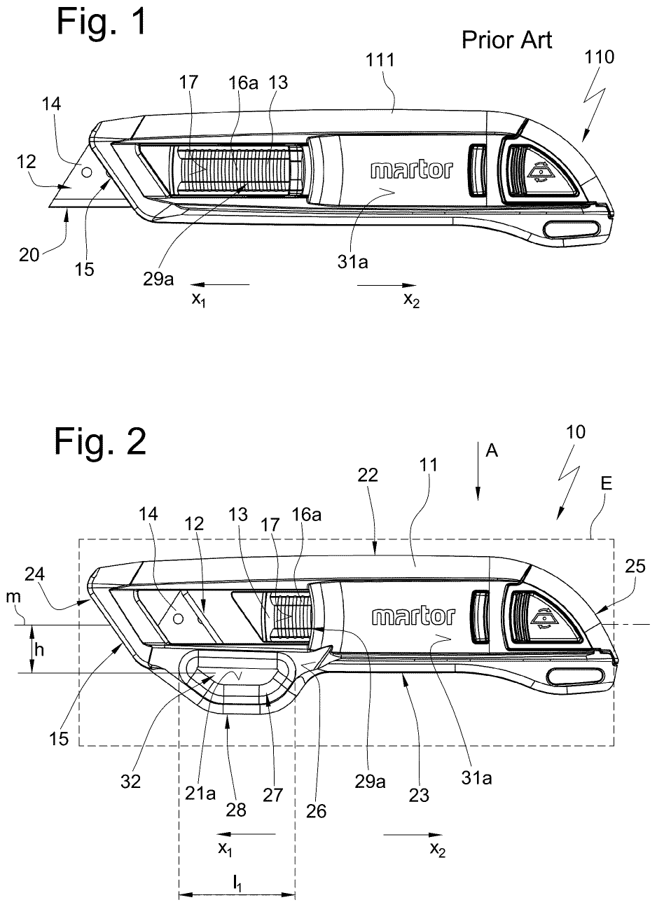

FIG. 1 is a side view of a knife from the prior art, wherein the blade device is arranged in the cutting position,

FIG. 2 is a side view of a knife according to the invention, wherein the blade device is arranged in the safety position,

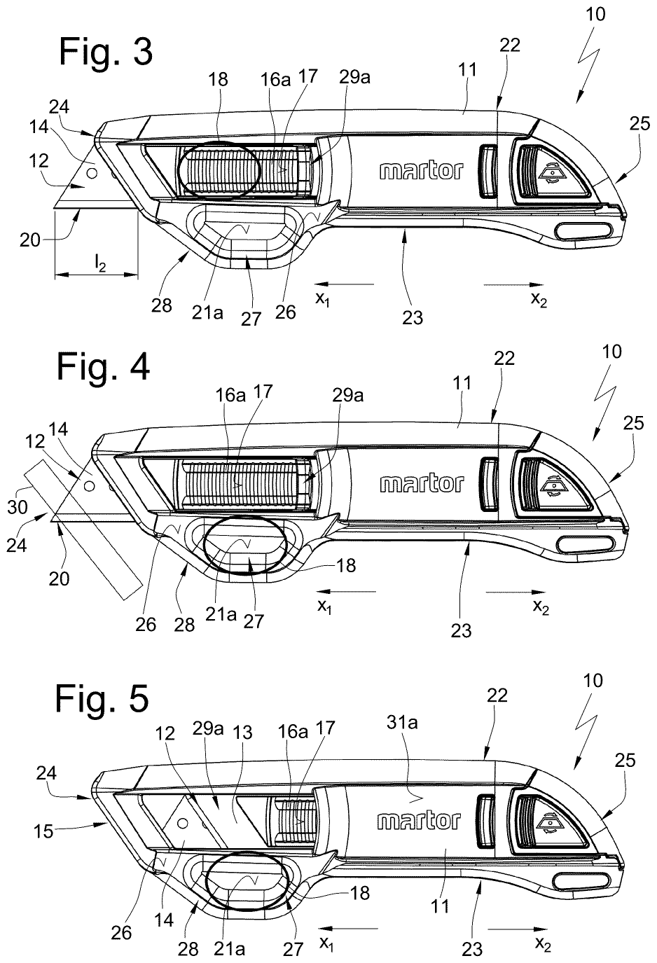

FIG. 3 is a side view of a knife according to the invention, wherein the blade device is located in the cutting position and an actuating finger is located on the actuation surface of the handle.

FIG. 4 is a side view based on FIG. 3, wherein the blade is in contact with the material to be cut and the actuating finger is resting on the contact surface,

FIG. 5 is a side view based on FIG. 2, wherein the blade device is in the safety position and the actuating finger is resting on the contact surface,

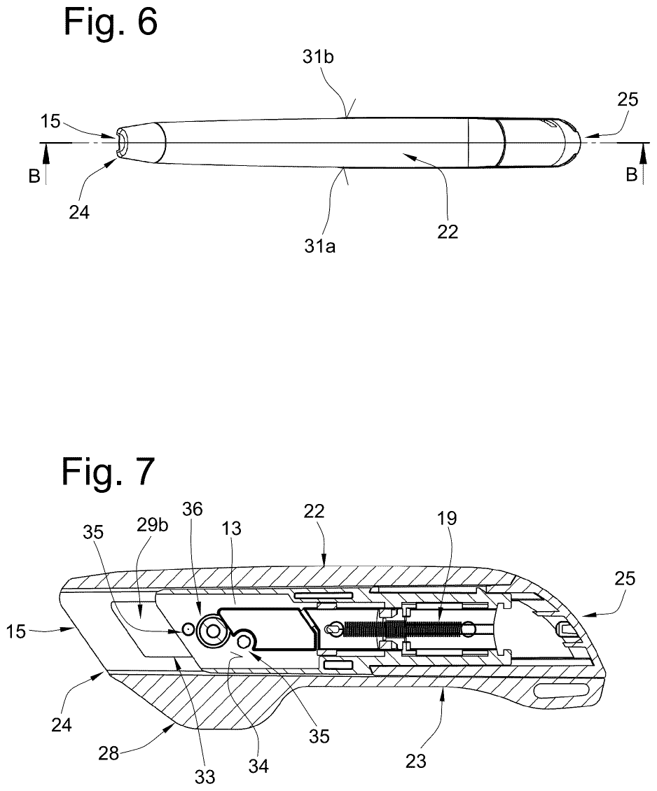

FIG. 6 is a view according to the viewing arrow A in FIG. 2,

FIG. 7 is a sectional view according to the cutting line B-B in FIG. 6,

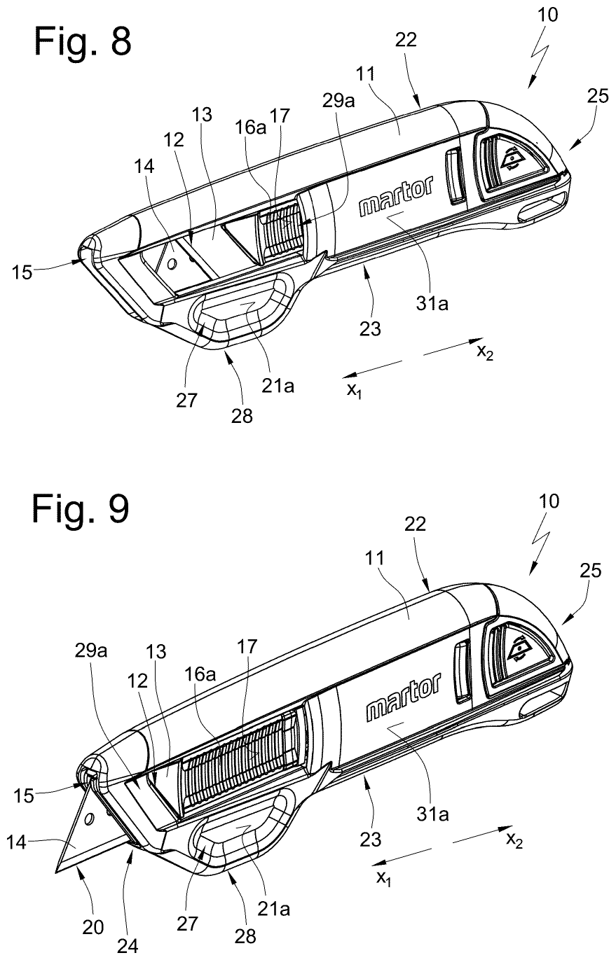

FIG. 8 is a perspective view of the knife, wherein the blade device is arranged in the safety position,

FIG. 9 is a perspective view of the knife according to FIG. 8, wherein the blade device is arranged in the cutting position,

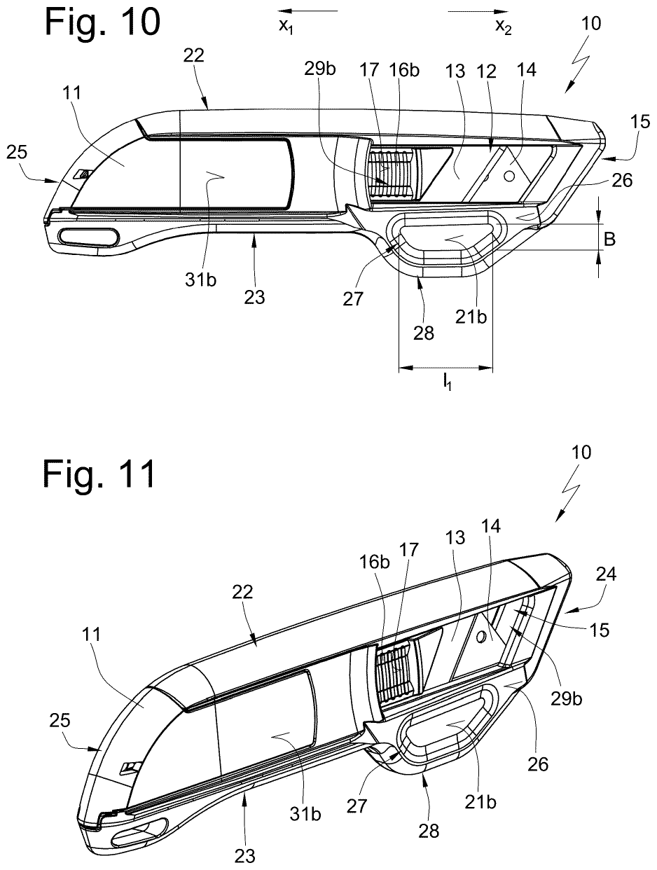

FIG. 10 is a side view of the knife from an opposite side with respect to FIG. 2,

FIG. 11 is a perspective view of the knife according to FIG. 10, obliquely from behind,

FIG. 1 shows a knife 110 from the prior art. The knife comprises a holder 111 in which a blade device 12, here comprising a blade carrier 13 and a blade 14, is movable between a safety position and a cutting position.

The holder 111 comprises lateral recesses 29a and 29b on opposing flank surfaces 31a and 31b of the holder 111, of which only the recess 29a is visible in FIG. 1. The recesses 29a and 29b allow the user to move the blade device 12 by means of a handle 16 into the cutting position shown in FIG. 1. Since the recesses 29a and 29b are formed on both flank surfaces 31a and 31b of the holder 111, the knife can be actuated by right-handed or by left-handed persons.

In the cutting position, a region of a cutting edge 20 of the blade device 12 emerges out of an opening 15 of the holder 111, and a cutting process can be carried out. FIG. 1 shows a cutting position, in which the cutting edge 20 is moved out of the holder 111 to a maximum extent and a stop of the blade device 12 is in contact with a surface of the holder 111. It is also possible to move the blade device 12 only to such an extent in direction x1 that the blade 20 emerges out of the holder 111 with a reduced length.

For movement, the handle 16a has an actuation surface 17 which can be contacted and moved with an actuating finger 18 (now shown in FIG. 1). The blade device 12 is loaded into the safety position by means of a return device 19. That is to say, when the handle 16a is unloaded the blade device 12 is moved back by the return force of the return device 19, in direction x2, into the safety position in which the cutting edge 20 is moved back into the holder 111 in such a way that the user cannot come into contact with the cutting edge 20.

The safety function of the automatic blade retraction is only possible when the user unloads the blade device 12, i.e. does not hold this in the cutting position, counter to the spring force acting in direction x2. Therefore, the user has to release the actuating finger 18 from the handle 16a after the blade 14 has been in contact with the material to be cut and the blade 14 has been held in the cutting position by the friction force between the blade 14 and material to be cut, counter to the spring force. The process takes place many times when working with the knife 110, which led to the actuating finger 10 tiring.

The knife according to the invention is denoted as a whole in FIG. 2 to 11 by reference sign 10.

The knife 10 is shown in the safety position in FIG. 2. The blade device 12 is retracted into a receiving space 33 of the holder 11. Injury on the cutting edge 20 is then not possible. The blade device 12 can be shifted counter to the force of a return device 19, acting in direction x2, out of the safety position corresponding to the knife 110 from the prior art, by means of the handle 16, in direction x1, into a cutting position, shown in FIG. 3. In the cutting position, a cutting edge 20 of the blade device 12 emerges from the housing-like holder 11 and a cutting process is possible.

The knife 10 according to the invention according to FIG. 2 to 7 differs from the knife 110 from the prior art merely in that the holder 11 comprises contact surfaces 21a and 21b for the actuating finger 18 for actuating the handles 16a and 16b. The contact surfaces 21a and 21b are provided for preventing the quick tiring, described above, of the actuating finger, in that the actuating finger 12 can be placed on the contact surface 21a or 21b after contact has been established between the blade device 12 and the material to be cut 30, and can remain on said surface until a new cutting process is performed.

The knife 10 described here is suitable for right-handed and left-handed persons, and therefore comprises recesses 29a and 29b, the handles 16a and 16b, and the contact surfaces 21a and 21b. Alternatively, the knife 10 could also be provided merely with a handle 16a for right-handed persons or with a handle 16b for left-handed persons. In this case, the knife 10 would also comprise just one contact surface 21a or 21b.

FIG. 2 shows a sagittal plane E of the knife 10 which extends through a central longitudinal axis m of the knife 10. The contact surfaces 21a and 21b are formed approximately in parallel with the sagittal plane E and in parallel with the actuation surface 17 of the handles 16a and 16b. A length 11 of the contact surfaces 21a and 21b is large for example in relation to its width B, e.g. twice as large. A side region of the fingertip of the actuating finger 18 can thus lean on the contact surface 21a or 21b.

It can be seen in FIG. 2 that the contact surface 21a is recessed with respect to the neighboring outer surface 26a of the holder 11. The transition from the outer surface 26a to the contact surface forms a ramp 27. The ramp 27 forms a protection against the actuating finger 18 slipping off the contact surface 21a. Furthermore, on account of the recessed contact surface 21a and the ramp 27, the contact surface 21a can be easily felt. The contact surface 21b (see FIGS. 10 and 11) is configured in the same way as the contact surface 21a. It is also configured as a depression with a ramp 27. The contact surfaces 21a and 21b can moreover comprise a structure 32 which prevents the actuating finger 18 from sliding off.

In the case of the knife 10 of the configuration described here, recesses 29a and 29b are formed on both flank surfaces 31a and 31b, through which recesses a handle 16a and 16b is actuatable in each case. Furthermore, contact surfaces 21a and 21b are also formed on the two flank surfaces 31a and 31b of the projection 28.

The knife 10 comprises a top side 22, a bottom side 23, a front end 24 and a rear end 15. In this embodiment, the contact surfaces 21a and 21b are formed on the projection 28 on the bottom side 23 of the holder 11. The user can then allow the actuating finger 18 to drop from the handle 16 onto the contact surface 21a or 21b, in an ergonomically advantageous manner. According to FIG. 2, a central region of the contact surface 21a is spaced apart from a central region of the actuation surface 17 by a spacing h. The spacing h is selected such that the contact surface 21a is located within reach of the actuating finger 18 which actuates the actuation surface 17.

In the following, an actuation on the handle 16a will be described by way of example. Proceeding from the state of the safety position of the blade device 12 according to FIG. 2, the user can move the handle 16a in direction x1, with the actuating finger 18 on the actuation surface 17, by increasing potential energy of the return device 19, which loads the blade device 12 in direction x2, until the cutting edge 20 of the blade device 12 emerges from the opening 15 at the front end 24 of the holder 11. A cutting position, in which the blade device 12 is moved to a maximum in direction x1, is shown in FIG. 3. The cutting edge 20 can alternatively, however, also be shifted into a cutting position, in which the cutting edge 20 emerges from the holder 11 with a reduced length 12. The length 12 denotes the length by which the cutting edge 20 projects beyond the holder 11 (see FIG. 3).

The return device 19 loads the blade device 12 in direction x2. Before the cutting process, the user has to hold the blade device 12 in the cutting position, counter to the force of the return device 19. When the blade device 12—here the blade 14—is in contact with a material to be cut (see FIG. 4), the friction force between the material to be cut 30 and the blade device 12 prevents a movement of the blade device 12 in direction x2, caused by the return device 19.

The actuating finger 18 can then, according to FIG. 4, be removed from the actuation surface 17 of the handle 16a and moved onto the contact surface 21a. This ensures the safety function, which can retract the cutting edge 20 into the holder 11, into the safety position, upon completion of the cutting process or an undesired sudden emergence of the blade device 12 from the material to be cut 30. In the event of the handle 16a being unloaded, the actuating finger 18 does not, however, have to be spread out from the holder 11, but rather can be positioned in a relaxed manner on the contact surface 21a.

The positioning of the actuating finger 18 on the contact surface 21a is also advantageous for the guidance of the knife 10 and thus the cut. Owing to the projection 28 which is spaced apart with respect to the central axis m, on which projection the contact surfaces 21a and 21b is formed, the exertion of a force in the direction of rotation about the central axis m of the holder 11 with a lever arm h is possible.

According to FIG. 5, after contact with the material to be cut 30 has ended, the blade device 12 has moved into the safety position. The actuating finger 18 is still in contact with the contact surface 21a. Only upon renewed actuation of the handle 16a into the cutting position does e.g. the actuating finger 18 move back onto the actuation surface 17.

FIG. 6 is a plan view of the top side 22 of the knife 10.

In FIG. 7 the receiving space 33 of the housing-like holder 11 is visible. The blade device 12 is movably guided in the receiving space 33. It can be seen that the return device 19 in this example comprises a spring, which is fastened to the blade device 12, here to the blade carrier 13 and to the holder 11, and is tensioned in the case of movement from the safety position into the cutting position. In this example, the return device 19 comprises merely one spring, but alternatively a plurality of springs or other return mechanisms could also be present, in order to load the blade device 12 into the safety position. In the sectional view according to FIG. 7, the blade 14 is not visible. A seat surface 34 for the blade 14 is visible, which comprises form-fitting connection means 35 and a magnet 36 for holding the blade 14.

FIGS. 8 and 9 are perspective views of the knife 10 in the safety position (FIG. 8) and in the cutting position (FIG. 9).

FIG. 10 is a side view of the knife 10, wherein the flank surface 31b of a side of the holder 11 shown opposite in FIG. 2 is visible. According to FIG. 10, the length 11 of the contact surface 21b is approximately twice the length of its width B.

FIG. 11 is a perspective view of this side that is shown in FIG. 10. It is clear from FIGS. 10 and 11 that a handle 16b can be actuated through the recess 29b. The knife 10 can therefore be actuated by right-handed and by left-handed persons. It can also be seen in FIGS. 10 and 11 that the projection 28 also provides a contact surface 21b for a user with left-handed actuation, which is configured to be recessed and is provided with a ramp 27, in the same manner as the contact surface 21a.

The holder 11 of the knife 10 and/or of the blade holder 13 can be produced e.g. from plastics material or alternatively from a metal casting.

In this embodiment, the blade 14 is a strip steel blade, which can be detached from the blade carrier 13 and replaced by another blade 14. For this purpose, the housing-like holder 11 is formed in two parts, such that it can be opened.

1-12. (canceled)

13. A knife, comprising: a holder; a blade device which is movable relative to the holder between a safety position and a cutting position; and at least one handle movable between an inactive position and an active position, wherein the holder provides a contact surface for an actuating finger with which the handle is actuated, within reach of the movement path of the handle.

14. The knife according to claim 13, wherein the holder is configured as a housing.

15. The knife according to claim 13, wherein the blade device is loaded into the safety position by a return device.

16. The knife according to claim 13, wherein the contact surface is parallel with a sagittal plane of the knife.

17. The knife according to claim 13, wherein the contact surface is formed on a projection of the holder.

18. The knife according to claim 13, wherein the contact surface is located approximately centrally between the position of the handle in the safety position and in the cutting position.

19. The knife according to claim 13, wherein the contact surface is arranged as a depression which has a recessed level relative to a neighboring outer surface of the holder.

20. The knife according to claim 19, wherein a transition from the contact surface to the neighboring outer surface comprises a ramp.

21. The knife according to claim 13, wherein the contact surface comprises a structure, at least in regions, which stabilizes the actuating finger.

22. The knife according to claim 13, wherein a length of the contact surface is greater than a width of the contact surface.

23. The knife according to claim 13, wherein in each case a handle and a contact surface is formed on flank surfaces of the holder arranged opposite one another.

24. The knife according to claim 13, wherein the holder is formed at least in part of a plastics material, a composite plastics material, or a metal casting.
